(19) United States
(12) Patent Application Publication
(10) Pub. No.: US 2026/0222878 A1
(43) Pub. Date: Jul. 30, 2026

(54) COMMUNICATION METHOD AND APPARATUS, DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/148,972

(22) PCT Filed: Jan. 18, 2023
(86) PCT No.: PCT/CN2023/072980

§ 371 Date: Jul. 17, 2025

(51) Int. Cl. H04W 24/10

(52) U.S. Cl. CPC H04W 24/10

(57) ABSTRACT

Embodiments of the present disclosure relate to the technical field of communications, and provide a communication method and apparatus, a device, and a storage medium. The method can be applied to a first device. The method comprises: determining a first message frame, wherein the first message frame is used for indicating whether a sensing measurement report frame carries time information or not, and the time information is used for indicating the receiving time or the sending time of a null data packet (NDP) frame; and sending the first message frame. According to the embodiments of the present disclosure, the mode of indicating whether the sensing measurement report frame carries the time information or not can be provided.

### CROSS-REFERENCE TO RELATED APPLICATION

This application is the U.S. national phase application of International Application No. PCT/CN2023/072980, filed on Jan. 18, 2023, the disclosure of which is incorporated herein by reference in its entirety.

### TECHNICAL FIELD

Examples of the present disclosure relate to the field of communication technologies. Particularly, the examples of the present disclosure relate to a communication method, apparatus, device, and a storage medium.

### BACKGROUND

A wireless local area network (WLAN) has advantages such as flexibility, mobility, and low cost. As communication technologies develop and user requirements grow, the research for WLAN applications is gradually progressing. For example, WLAN sensing, which is a current subject of ongoing research, has major application scenarios such as location discovery, proximity detection, presence detection and environment detection (e.g., human movements) in a dense environment (such as a home environment or a company environment).

In some sensing measurement procedures, a sensing receiver may carry a timestamp, which indicates a reception time or a transmission time of a null data packet (NDP) frame, in a sensing measurement report frame according to actual measurement requirements. However, current research has not clearly defined a mechanism for determining whether the sensing receiver is to carry the timestamp in the sensing measurement report frame.

### SUMMARY

In a first aspect, the examples of the present disclosure provide a communication method, performed by a first device, and the method includes: determining a first frame, wherein the first frame indicates whether a sensing measurement report frame carries time information or not, and the time information indicates a reception time or a transmission time of a null data packet (NDP) frame; and transmitting the first frame.

In a second aspect, the examples of the present disclosure provide a communication method, performed by a second device, and the method includes: receiving a first frame, wherein the first frame indicates whether a sensing measurement report frame carries time information or not, and the time information indicates a reception time or a transmission time of an NDP frame.

In a third aspect, the examples of the present disclosure further provide an electronic device, including one or more memories, one or more processors, and a computer program stored in the one or more memories and executable on the one or more processors. The one or more processors are configured to: determine a first frame, wherein the first frame indicates whether a sensing measurement report frame carries time information or not, and the time information indicates a reception time or a transmission time of a null data packet (NDP) frame; and transmit the first frame.

Additional aspects and advantages of the examples of the present disclosure are set in the following description, and learned through putting the present disclosure into practice.

### BRIEF DESCRIPTION OF THE DRAWINGS

The drawings used in the description of the examples of the present disclosure are briefly introduced below to explain the technical solutions. It is evident that, the drawings in the following description illustrate only some examples of the present disclosure, and based on these drawings, those of ordinary skill in the art may obtain other drawings without creative work.

FIG. 1 is a schematic architectural diagram of a WLAN sensing measurement provided in an example of the present disclosure.

FIG. 2 is a schematic diagram of communication connections provided in an example of the present disclosure.

FIG. 3 is another schematic architectural diagram of a WLAN sensing measurement provided in an example of the present disclosure.

FIG. 4 is a schematic flowchart of a communication method provided in an example of the present disclosure.

FIG. 5 is another schematic flowchart of a communication method provided in an example of the present disclosure.

FIG. 6 is a schematic structural diagram of a communication apparatus provided in an example of the present disclosure.

FIG. 7 is another schematic structural diagram of a communication apparatus provided in an example of the present disclosure.

FIG. 8 is a schematic structural diagram of an electronic device provided in an example of the present disclosure.

### DETAILED DESCRIPTION OF THE EMBODIMENTS

The term “and/or” in examples of the present disclosure describes association relationships between associated objects, indicating that there may be three types of relationships. For example, A and/or B means that A exists alone, A and B exist at the same time, and B exists alone. The character “/” generally indicates that the associated objects before and after are in an “or” relationship.

The term “plurality of” in the examples of the present disclosure refers to two or more than two, and other quantifiers are similar thereto.

The examples will be described in detail herein, with illustrations shown in the accompanying drawings. Note that, in the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a,” “said,” and “the” in their singular forms in the present disclosure and the appended claims are also intended to include their plural forms, unless clearly indicated otherwise in the context. It is also understood that the term “and/or” as used herein is and includes any possible combinations of one or more of the associated listed items.

It is to be understood that, although terms “first,” “second,” “third,” and the like may be used in the present disclosure to describe various information, such information should not be limited to these terms. These terms are only used to distinguish the information of the same type from each other. For example, without departing from the scope of the present disclosure, first information may be referred to as second information. Similarly, second information may also be referred to as first information. Depending on the context, the word “if” as used herein may be interpreted as “when,” “upon,” or “in response to determining.”

The following, in conjunction with the drawings of the examples of the present disclosure, will clearly and completely describe the technical solutions provided in the examples of the present disclosure. It is evident that the described examples are a part, but not all, of the examples of the present disclosure. Based on the examples provided in the present disclosure, all other examples, which can be obtained by those of ordinary skill in the art without creative work, shall fall within the protection scope of the present disclosure.

The examples of the present disclosure provide a communication method, apparatus, device, and a storage medium, which may provide a mechanism to indicate whether a sensing receiver is to carry time information in a sensing measurement report frame.

According to the communication method provided in the examples of the present disclosure, a sensing initiator may indicate through a first frame whether a sensing receiver is to carry time information for indicating a reception time or a transmission time of an NDP frame in a sensing measurement report frame.

The methods and the apparatuses are based on the same disclosed concept. For the methods and the apparatuses, their implementations can refer to each other since their principles of solving problems are similar, and their repeated parts are not repeated.

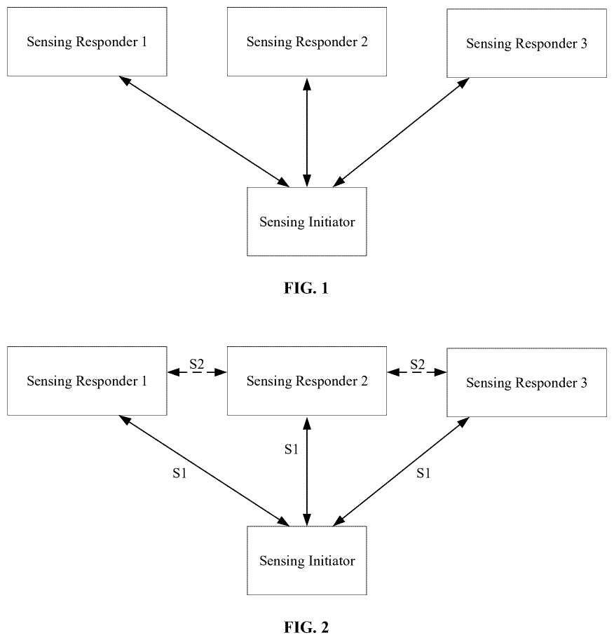

As a first example, referring to FIG. 1 to FIG. 3, wireless local area network (WLAN) sensing measurement architectures and WLAN sensing measurement procedures to which communication methods provided in the examples of the present disclosure are first introduced.

FIG. 1 illustrates a schematic architectural diagram of a WLAN sensing measurement. A sensing initiator initiates the WLAN sensing measurement (e.g., initiates a WLAN sensing measurement session). There may be a plurality of sensing responders responding thereto, such as Responder 1, Responder 2, and Responder 3, as illustrated in FIG. 1. When the sensing initiator initiates the WLAN sensing measurement, the plurality of associated or unassociated sensing responders for the WLAN sensing measurement may perform the response.

Being “associated” herein may refer to an initial association link for communications that has been established between the sensing initiator and the sensing responder, and being “unassociated” may refer to no initial association link for communications that has been established between the sensing initiator and the sensing responder.

Referring to FIG. 2, the sensing initiator communicates with the sensing responders via communication links, as illustrated by communication links S1, and the sensing responders communicate with each other via communication links S2.

Each sensing initiator may be a client, and each sensing responder (i.e., Sensing Responder 1 to Sensing Responder 3 in the example) may be a station (STA) or an access point (AP).

The AP is a wireless switch used in a wireless network or is an access device for the wireless network. The AP may include software applications and/or circuits to enable other types of nodes in the wireless network to communicate externally and internally to the wireless network through the AP. For example, the AP may be a terminal device or a network device equipped with a wireless fidelity (Wi-Fi) chip.

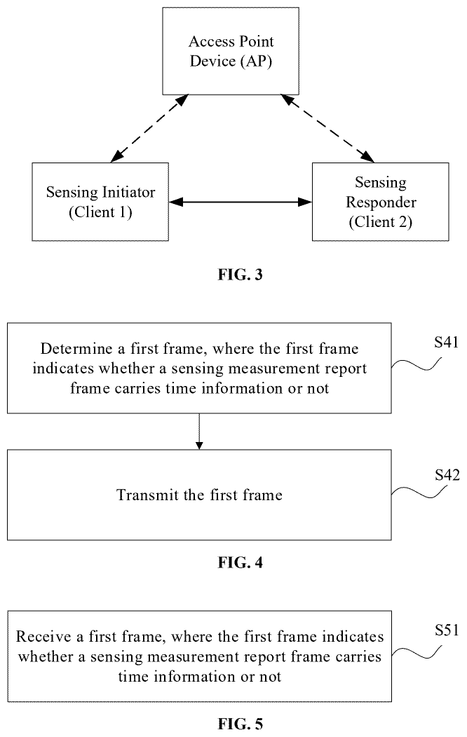

As another architecture, as illustrated in FIG. 3, the sensing initiator and the sensing responder may both be clients, and the two may communicate by connecting to the same AP. In FIG. 3, Client 1 is the sensing initiator, and Client 2 is the sensing responder.

The client may include, but is not limited to, a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

The AP may be the wireless switch applied in the wireless network, or the AP may be the access device for the wireless network. The AP may include software applications and/or circuits to enable other types of nodes in the wireless network to communicate externally and internally to the wireless network through the AP. As an example, the AP may be the terminal device or the network device equipped with the Wi-Fi chip.

As an illustrative example, a WLAN sensing procedure may include a WLAN sensing session setup, a WLAN sensing measurement setup, and a WLAN sensing measurement termination. In the WLAN sensing session setup, the sensing initiator (e.g., the AP) may initiate a WLAN sensing session, the sensing responder (e.g., the STA) may respond thereto, and operating parameters associated with the sensing session may be determined and exchanged between the devices. One WLAN sensing session setup may include one or more WLAN sensing measurement setups. That is, one or more sensing measurements may be established between the sensing initiator (e.g., the AP) and the sensing responder (e.g., the STA). For example, each WLAN sensing measurement may be identified by a corresponding measurement setup identifier (MSID) or by the MSID containing a plurality of sensing instance IDs. The WLAN sensing measurement corresponding to each measurement setup identifier (ID) may include one or more WLAN sensing measurement instances. The sensing measurement may be performed for each WLAN sensing measurement instance.

A sensing measurement procedure may involve a plurality of roles, such as the sensing initiator, the sensing responder, a sensing transmitter, and a sensing receiver. For one sensing procedure, the sensing initiator initiates the sensing measurement procedure, the sensing responder participates in the sensing measurement procedure initiated by the sensing initiator, the sensing transmitter transmits a null data packet (NDP) frame, and the sensing receiver may use the received NDP frame to perform the sensing measurement and feed a sensing measurement result back to the sensing initiator. It can be seen that the functions of the plurality of roles do not conflict with each other. In other words, for the devices in the sensing measurement procedure, one device may play one or more roles. For example, the sensing initiator, the sensing responder, the sensing transmitter, and the sensing receiver may be the same device, or may be two different devices.

The examples of the present disclosure provide a communication method that may be applied to a first device. Specifically, it may refer to FIG. 4. FIG. 4 is a schematic flowchart of a communication method provided in an example of the present disclosure.

In one or more examples, the first device is a sensing initiator.

In one or more examples, the method may include the following steps.

At step S41, a first frame is determined, where the first frame indicates whether a sensing measurement report frame carries time information or not.

Specifically, the first frame indicates whether the sensing receiver is to carry the time information in the sensing measurement report frame upon feeding the sensing measurement report frame back.

The time information includes a timestamp that indicates a reception time or a transmission time of an NDP frame, that is, indicates the time when the sensing receiver receives the NDP frame or the time when the sensing transmitter transmits the NDP frame.

The sensing receiver performs a sensing measurement based on the received NDP frame and reports a sensing measurement result through the sensing measurement report frame.

The NDP frame includes relevant parameters required for performing the WLAN sensing measurement, such as counts of spatial streams, a working bandwidth, a long training field (LTF), and a packet extension (PE) field, but is not limited thereto.

The sensing measurement results of a plurality of sensing measurement procedures may be aggregated into one sensing measurement report frame.

At step S42, the first frame is transmitted.

After determining the first frame, the first device transmits the first frame to a second device during negotiating a sensing measurement setup with the second device.

In one or more examples, the second device may be a sensing responder. That is, the sensing initiator transmits the first frame to the sensing responder during negotiating the sensing measurement setup with the sensing responder.

In the communication method applied to the first device provided in an example of the present disclosure, the first frame includes a first identifier bit.

When the value of the first identifier bit includes a first value, the first frame indicates that the sensing measurement report frame carries the time information. That is, it specifically indicates that the sensing receiver is to carry the time information in the sensing measurement report frame upon feeding the sensing measurement report frame back.

When the value of the first identifier bit includes a second value, the first frame indicates that the sensing measurement report frame does not carry the time information. That is, it specifically indicates that the sensing receiver is not to carry the time information in the sensing measurement report frame upon feeding the sensing measurement report frame back.

The first value and the second value are different. For example, the first value may be one (1) and the second value may be zero (0), which is not limited to the example of the present disclosure.

The first identifier bit includes at least one bit, which is not limited herein.

In the communication method applied to the first device provided in an example of the present disclosure, the first frame includes sensing measurement parameter element fields, and the sensing measurement parameter element fields include the first identifier bit.

In one or more examples, the first frame includes the sensing measurement parameter element fields that include a sensing measurement parameter field, and the sensing measurement parameter field includes the first identifier bit.

The format of the sensing measurement parameter element fields may be:

| | | | Element | Sensing | |
|---|---|---|---|---|---|
| | Element | | ID | Measurement | Sensing |
| | ID | Length | Extension | Parameters | subelements |
| Octets | 1 | 1 | 1 | 5 | Variable |

The Element ID refers to an element ID field, the Length refers to an element length field, the Element ID Extension refers to an element ID extension field, the Sensing Measurement Parameters refer to the sensing measurement parameter field, and the Sensing subelements refer to a sensing subelement field.

The sensing measurement parameter field includes the first identifier bit.

The communication method applied to the first device provided in an example of the present disclosure further includes: determining a second frame, where the second frame indicates that the first device supports carrying the time information in the sensing measurement report frame.

In the case where the first device is the sensing initiator, the second frame indicates that the sensing initiator supports carrying the time information in the sensing measurement report frame.

The second frame is transmitted.

The first device may transmit the second frame during establishing a sensing session with the second device. When the first device is the sensing initiator and the second device is the sensing responder, the sensing initiator indicates, through the second frame, that the sensing initiator supports carrying the time information in the sensing measurement report frame.

The second frame includes a second identifier bit. When the value of the second identifier bit is a third value, the second frame indicates that the first device supports carrying the time information in the sensing measurement report frame. The third value is not limited in the example of the present disclosure, for example, the third value may be 1.

Specifically, the first device transmits the second frame before transmitting the first frame. That is, on the premise that the first device supports carrying the time information in the sensing measurement report frame, the first device transmits the first frame to the second device to indicate whether the sensing measurement report frame carries the time information or not.

Specifically, when the first device is the sensing initiator and the second device is the sensing responder, the sensing initiator transmits the second frame before transmitting the first frame. That is, on the premise that the sensing initiator supports carrying the time information in the sensing measurement report frame, the sensing initiator transmits the first frame to the sensing responder to indicate whether the sensing receiver is to carry the time information in the sensing measurement report frame.

The communication method applied to the first device provided in an example of the present disclosure further includes: receiving a third frame, where the third frame indicates that the second device supports carrying the time information in the sensing measurement report frame.

In one or more examples, the second device may be the sensing responder.

The first device may receive the third frame during establishing the sensing session with the second device, so as to determine, according to the third frame, that the second device supports carrying the time information in the sensing measurement report frame.

When the first device is the sensing initiator and the second device is the sensing responder, the sensing initiator may receive the third frame during establishing the sensing session with the sensing responder, so as to determine, according to the third frame, that the sensing responder supports carrying the time information in the sensing measurement report frame.

The third frame includes a third identifier bit. When the value of the third identifier bit includes a fourth value, the third frame indicates that the second device supports carrying the time information in the sensing measurement report frame. The fourth value is not limited in the example of the present disclosure, for example, the fourth value may be one (1).

The first device may receive the third frame before transmitting the first frame. That is, on the premise that the second device supports carrying the time information in the sensing measurement report frame, the first device transmits the first frame to the second device to indicate whether the sensing measurement report frame carries the time information or not.

Specifically, when the first device is the sensing initiator and the second device is the sensing responder, the sensing initiator receives the third frame before transmitting the first frame. That is, on the premise that the sensing responder supports carrying the time information in the sensing measurement report frame, the sensing initiator transmits the first frame to the sensing responder to indicate whether the sensing receiver is to carry the time information in the sensing measurement report frame.

The communication method applied to the first device provided in an example of the present disclosure further includes: transmitting the second frame and receiving the third frame.

The second frame indicates that the first device supports carrying the time information in the sensing measurement report frame, and the third frame indicates that the second device supports carrying the time information in the sensing measurement report frame.

The first device may be the sensing initiator, and the second device may be the sensing responder. The sensing initiator may transmit the second frame to the sensing responder and receive the third frame transmitted by the sensing responder during establishing of the sensing session with the sensing responder. That is, on the premise that the sensing initiator and the sensing responder support carrying the time information in the sensing measurement report frame, the sensing initiator transmits the first frame to the sensing responder, where the first frame indicates whether the sensing receiver is to carry the time information in the sensing measurement report frame.

In the communication method applied to the first device provided in an example of the present disclosure, the first frame includes the first identifier bit when the first device is the sensing transmitter.

The first device may be the sensing initiator. That is, when the first device is both the sensing initiator and the sensing transmitter, the first frame includes the first identifier bit.

In the case where the first device is both the sensing initiator and the sensing transmitter, the first device may also be the sensing receiver at the same time.

In one or more examples, the first frame includes the sensing measurement parameter element fields that include the sensing measurement parameter field, and the sensing measurement parameter field includes a fourth identifier bit. When the value of the fourth identifier bit includes a fifth value, the fourth identifier bit indicates that the first device is the sensing transmitter, or indicates that the first device is both the sensing transmitter and the sensing receiver at the same time.

The fifth value may be 1, which is not limited to the example of the present disclosure.

The fourth identifier bit may be a sensing measurement report requested information field, or may be at least one bit in the sensing measurement parameter element fields or the sensing measurement parameter field, which is not limited to the example of the present disclosure.

When the first device is the sensing transmitter and regardless of whether the first device is the sensing receiver, the first device may indicate, through the first frame during negotiating the sensing measurement setup with the sensing responder, whether the sensing receiver is to carry the time information in the sensing measurement report frame upon feeding the sensing measurement report frame back.

When the first device is the sensing receiver, the first device may determine the time information based on the NDP frame and decide whether to carry the time information in the sensing measurement report frame during negotiating the sensing measurement setup with the second device. In this case, the first frame transmitted by the first device does not include the first identifier bit.

In the communication method applied to the first device provided in an example of the present disclosure, the first frame includes a sensing measurement setup request frame.

In the communication method applied to the first device provided in an example of the present disclosure, in the case where the first device transmits the second frame to the second device, the second frame includes any one of a beacon frame, a probe request frame, or a sensing query frame.

As an example, when the first device is the sensing initiator and the second device is the sensing responder, the sensing initiator transmits the beacon frame or the probe request frame to the sensing responder during establishing the sensing session with the sensing responder, so as to indicate, through the beacon frame or the probe request frame, that the first device supports carrying the time information in the sensing measurement report frame.

In the communication method applied to the first device provided in an example of the present disclosure, in the case where the first device receives the third frame transmitted by the second device, the third frame includes any one of a beacon frame or a probe response frame.

As an example, when the first device is the sensing initiator and the second device is the sensing responder, the first device receives the beacon frame or the probe response frame transmitted by the second device during establishing the sensing session with the second device, so as to determine, according to the beacon frame or the probe response frame, that the second device supports carrying the time information in the sensing measurement report frame.

In the communication method applied to the first device provided in an example of the present disclosure, the second frame includes sensing element fields, and the sensing element fields include the second identifier bit.

In one or more examples, the second frame includes the sensing element fields that include a sensing field, and the sensing field includes the second identifier bit.

The format of the sensing element fields may be:

| | Element | | Element ID | |
|---|---|---|---|---|
| | ID | Length | Extension | Sensing |
| Octets | 1 | 1 | 1 | 9 |

The Element ID refers to an element ID field, the Length refers to an element length field, the Element ID Extension refers to an element ID extension field, the Sensing refers to a sensing field, and the sensing field in the second frame includes the second identifier bit.

In the communication method applied to the first device provided in an example of the present disclosure, the third frame includes sensing element fields, and the sensing element fields include the third identifier bit.

In one or more examples, the third frame includes the sensing element fields that include a sensing field, and the sensing field includes the third identifier bit.

The format of the sensing element fields may be:

| | Element | | Element ID | |
|---|---|---|---|---|
| | ID | Length | Extension | Sensing |
| Octets | 1 | 1 | 1 | 9 |

The Element ID refers to an element ID field, the Length refers to an element length field, the Element ID Extension refers to an element ID extension field, the Sensing refers to a sensing field, and the sensing field in the third frame includes the third identifier bit.

In the communication methods applied to the first device provided in the examples of the present disclosure, the format example of any frame is merely an example, and is not a limitation of the present disclosure. Counts of bytes (Octet) of any information field are also only illustrative, and may have different variants as required. For example, the counts of bytes of the sensing subelements field are variable. In addition, the information fields in each frame exist independently. These information fields are listed correspondingly in one table as an example, but it does not mean that all information fields in the table must exist at the same time as shown in the table. The value of each information field in each frame is independent of the value of any other information field. Therefore, those skilled in the art may understand that the value of each information field in each frame is an independent example.

The examples of the present disclosure provide a communication method that may be applied to a second device. Specifically, it may refer to FIG. 5. FIG. 5 is another schematic flowchart of a communication method provided in an example of the present disclosure.

In one or more examples, the second device is a sensing responder.

In one or more examples, the method may include the following steps.

At step S51, a first frame is received, where the first frame indicates whether a sensing measurement report frame carries time information or not.

Specifically, the first frame indicates whether the sensing receiver is to carry the time information in the sensing measurement report frame upon feeding the sensing measurement report frame back.

The time information includes a timestamp that indicates a reception time or a transmission time of an NDP frame, that is, indicates the time when the sensing receiver receives the NDP frame or the time when the sensing transmitter transmits the NDP frame.

The sensing receiver performs a sensing measurement based on the received NDP frame and reports a sensing measurement result through the sensing measurement report frame.

The NDP frame includes relevant parameters required for performing the WLAN sensing measurement, such as counts of spatial streams, a working bandwidth, an LTF, and a PE field, but is not limited thereto.

The sensing measurement results of a plurality of sensing measurement procedures may be aggregated into one sensing measurement report frame.

The second device receives the first frame transmitted by a first device during negotiating a sensing measurement setup with the first device.

In the communication method applied to the second device provided in an example of the present disclosure, the first frame includes a first identifier bit.

When the value of the first identifier bit includes a first value, the first frame indicates that the sensing measurement report frame carries the time information. That is, it specifically indicates that the sensing receiver is to carry the time information in the sensing measurement report frame upon feeding the sensing measurement report frame back.

When the value of the first identifier bit includes a second value, the first frame indicates that the sensing measurement report frame does not carry the time information. That is, it specifically indicates that the sensing receiver is not to carry the time information in the sensing measurement report frame upon feeding the sensing measurement report frame back.

The first value and the second value are different. For example, the first value may be one (1) and the second value may be zero (0), which is not limited to the example of the present disclosure.

The first identifier bit includes at least one bit, which is not limited here.

In the communication method applied to the second device provided in an example of the present disclosure, the first frame includes sensing measurement parameter element fields, and the sensing measurement parameter element fields include the first identifier bit.

In one or more examples, the first frame includes the sensing measurement parameter element fields that include a sensing measurement parameter field, and the sensing measurement parameter field includes the first identifier bit.

The format of the sensing measurement parameter element fields may be:

| | | | | Sensing | |
|---|---|---|---|---|---|
| | Element | | Element ID | Measurement | Sensing |
| | ID | Length | Extension | Parameters | subelements |
| Octets | 1 | 1 | 1 | 5 | Variable |

The Element ID refers to an element ID field, the Length refers to an element length field, the Element ID Extension refers to an element ID extension field, the Sensing Measurement Parameters refer to the sensing measurement parameter field, and the Sensing subelements refer to a sensing subelement field.

The sensing measurement parameter field includes the first identifier bit.

The communication method applied to the second device provided in an example of the present disclosure further includes: receiving a second frame, where the second frame indicates that the first device supports carrying the time information in the sensing measurement report frame.

In the case where the first device is the sensing initiator, the second frame indicates that the sensing initiator supports carrying the time information in the sensing measurement report frame.

The second device may receive the second frame during establishing a sensing session with the first device. When the first device is the sensing initiator and the second device is the sensing responder, the sensing receiver determines, according to the second frame, that the sensing initiator supports carrying the time information in the sensing measurement report frame.

The second frame includes a second identifier bit. When the value of the second identifier bit is a third value, the second frame indicates that the first device supports carrying the time information in the sensing measurement report frame. The third value is not limited in the example of the present disclosure, for example, the third value may be 1.

The second device may receive the second frame before receiving the first frame. That is, on the premise that the first device supports carrying the time information in the sensing measurement report frame, the second device receives the first frame that is transmitted by the first device and is used to indicate whether the sensing measurement report frame carries the time information or not.

Specifically, when the first device is the sensing initiator and the second device is the sensing responder, the sensing responder receives the second frame transmitted by the sensing initiator before receiving the first frame. That is, on the premise that the sensing initiator supports carrying the time information in the sensing measurement report frame, the sensing responder receives the first frame that is transmitted by the sensing initiator and is used to indicate whether the sensing receiver is to carry the time information in the sensing measurement report frame.

The communication method applied to the second device provided in an example of the present disclosure further includes: determining a third frame, where the third frame indicates that the second device supports carrying the time information in the sensing measurement report frame; and transmitting the third frame.

In one or more examples, the second device may be the sensing responder.

The second device may transmit the third frame during establishing the sensing session with the first device, so as to indicate, through the third frame, that the second device supports carrying the time information in the sensing measurement report frame.

When the first device is the sensing initiator and the second device is the sensing responder, the sensing responder may transmit the third frame during establishing the sensing session with the sensing initiator, so as to indicate, through the third frame, that the sensing responder supports carrying the time information in the sensing measurement report frame.

The third frame includes a third identifier bit. When the value of the third identifier bit includes a fourth value, the third frame indicates that the second device supports carrying the time information in the sensing measurement report frame. The fourth value is not limited in the example of the present disclosure, for example, the fourth value may be 1.

Specifically, the second device transmits the third frame to the first device before receiving the first frame. That is, on the premise that the second device supports carrying the time information in the sensing measurement report frame, the second device receives the first frame transmitted by the first device, where the first frame indicates whether the sensing receiver carries the time information in the sensing measurement report frame.

Specifically, when the first device is the sensing initiator and the second device is the sensing responder, the sensing responder transmits the third frame to the sensing initiator before receiving the first frame. That is, on the premise that the sensing responder supports carrying the time information in the sensing measurement report frame, the sensing responder receives the first frame transmitted by the sensing initiator, where the first frame indicates whether the sensing receiver is to carry the time information in the sensing measurement report frame.

The communication method applied to the second device provided in an example of the present disclosure further includes: receiving the second frame and transmitting the third frame.

The second frame indicates that the first device supports carrying the time information in the sensing measurement report frame, and the third frame indicates that the second device supports carrying the time information in the sensing measurement report frame.

The first device may be the sensing initiator, and the second device may be the sensing responder. The sensing responder may receive the second frame transmitted by the sensing initiator and transmit the third frame to the sensing initiator during establishing of the sensing session with the sensing initiator. That is, on the premise that the sensing initiator and the sensing responder support carrying the time information in the sensing measurement report frame, the sensing responder receives the first frame that is transmitted by the sensing initiator and is used to indicate whether the sensing receiver is to carry the time information in the sensing measurement report frame.

In the communication method applied to the second device provided in an example of the present disclosure, the first frame includes the first identifier bit when the first device is the sensing transmitter.

The first device may be the sensing initiator, that is, when the first device is both the sensing initiator and the sensing transmitter, the second device may be the sensing responder and the sensing receiver at the same time, and the first frame includes the first identifier bit.

In the case where the first device is both the sensing initiator and the sensing transmitter, the first device may also be the sensing receiver at the same time. In this case, the second device is the sensing responder.

In one or more examples, the first frame includes the sensing measurement parameter element fields that include the sensing measurement parameter field, and the sensing measurement parameter field includes a fourth identifier bit. When the value of the fourth identifier bit includes a fifth value, the fourth identifier bit indicates that the first device is the sensing transmitter, or indicates that the first device is both the sensing transmitter and the sensing receiver at the same time.

The fifth value may be 1, which is not limited to the example of the present disclosure.

The fourth identifier bit may be a sensing measurement report requested information field, or may be at least one bit in the sensing measurement parameter element fields or the sensing measurement parameter field, which is not limited to the example of the present disclosure.

When the first device is the sensing transmitter and regardless of whether the first device is the sensing receiver, the first device may indicate, through the first frame during negotiating the sensing measurement setup with the sensing responder, whether the sensing receiver is to carry the time information in the sensing measurement report frame upon feeding the sensing measurement report frame back.

When the first device is the sensing receiver, the first device may determine the time information based on the NDP frame and decide whether to carry the time information in the sensing measurement report frame during negotiating the sensing measurement setup with the second device. In this case, the first frame transmitted by the first device does not include the first identifier bit.

In the communication method applied to the second device provided in an example of the present disclosure, the first frame includes a sensing measurement setup request frame.

In the communication method applied to the second device provided in an example of the present disclosure, in the case where the second device receives the second frame transmitted by the first device, the second frame includes any one of a beacon frame, a probe request frame, or a sensing query frame.

As an example, when the first device is the sensing initiator and the second device is the sensing responder, the sensing responder receives the beacon frame or the probe request frame transmitted by the sensing initiator during establishing the sensing session with the sensing initiator, so as to determine, according to the second identifier bit included in the beacon frame or the probe request frame, that the sensing initiator supports carrying the time information in the sensing measurement report frame.

In the communication method applied to the second device provided in an example of the present disclosure, in the case where the second device transmits the third frame to the first device, the third frame includes any one of a beacon frame or a probe response frame.

As an example, when the first device is the sensing initiator and the second device is the sensing responder, the sensing responder transmits the beacon frame or the probe response frame to the sensing initiator during establishing the sensing session with the sensing initiator, so as to indicate, through the third identifier bit included in the beacon frame or the probe response frame, that the sensing responder supports carrying the time information in the sensing measurement report frame.

In the communication method applied to the second device provided in an example of the present disclosure, the second frame includes sensing element fields, and the sensing element fields include the second identifier bit.

In one or more examples, the second frame includes the sensing element fields that include a sensing field, and the sensing field includes the second identifier bit.

The format of the sensing element fields may be:

| | Element | | Element ID | |
|---|---|---|---|---|
| | ID | Length | Extension | Sensing |
| Octets | 1 | 1 | 1 | 9 |

The Element ID refers to an element ID field, the Length refers to an element length field, the Element ID Extension refers to an element ID extension field, the Sensing refers to a sensing field, and the sensing field in the second frame includes the second identifier bit.

In the communication method applied to the second device provided in an example of the present disclosure, the third frame includes sensing element fields, and the sensing element fields include the third identifier bit.

In one or more examples, the third frame includes the sensing element fields that include a sensing field, and the sensing field includes the third identifier bit.

The format of the sensing element fields may be:

| | Element | | Element ID | |
|---|---|---|---|---|
| | ID | Length | Extension | Sensing |
| Octets | 1 | 1 | 1 | 9 |

The Element ID refers to an element ID field, the Length refers to an element length field, the Element ID Extension refers to an element ID extension field, the Sensing refers to a sensing field, and the sensing field in the third frame includes the third identifier bit.

In the communication methods applied to the second device provided in the examples of the present disclosure, the format example of any frame is merely an example, and is not a limitation of the present disclosure. Counts of bytes (Octet) of any information field are also only illustrative, and may have different variants as required. For example, the counts of bytes of the sensing subelements field are variable. In addition, the information fields in each frame exist independently. These information fields are listed correspondingly in one table as an example, but it does not mean that all information fields in the table must exist at the same time as shown in the table. The value of each information field in each frame is independent of the value of any other information field. Therefore, those skilled in the art may understand that the value of each information field in each frame is an independent example.

Based on the communication method provided in the examples of the present disclosure, the first device may transmit the first frame during negotiating the sensing measurement setup with the second device, so as to indicate through the first frame whether the sensing receiver is to carry the time information in the sensing measurement report frame upon feeding the sensing measurement report frame back. The time information indicates the reception time or the transmission time of the NDP frame.

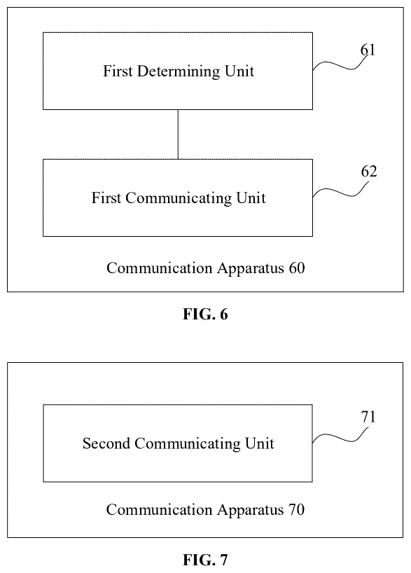

As illustrated in FIG. 6, an example of the present disclosure provides a communication apparatus 60, including a first determining unit 61 and a first communicating unit 62.

The first determining unit 61 is configured to determine a first frame, where the first frame indicates whether a sensing measurement report frame carries time information or not, and the time information indicates a reception time or a transmission time of an NDP frame.

The first communicating unit 62 is configured to transmit the first frame.

Alternatively, or additionally, in an example of the present disclosure, the first frame includes a first identifier bit. When the value of the first identifier bit includes a first value, the first frame indicates that the sensing measurement report frame carries the time information. When the value of the first identifier bit includes a second value, the first frame indicates that the sensing measurement report frame does not carry the time information.

Alternatively, or additionally, in an example of the present disclosure, the first frame includes sensing measurement parameter element fields, and a sensing measurement parameter field in the sensing measurement parameter element fields includes the first identifier bit.

Alternatively, or additionally, in an example of the present disclosure, the communication apparatus is a sensing initiator, and the sensing initiator is a sensing transmitter.

Alternatively, or additionally, in an example of the present disclosure, the first determining unit 61 is further configured to determine a second frame. The second frame indicates that the communication apparatus supports carrying the time information in the sensing measurement report frame.

The first communicating unit 62 is further configured to transmit the second frame.

Alternatively, or additionally, in an example of the present disclosure, the first communicating unit 62 is further configured to receive a third frame. The third frame indicates that a second device supports carrying the time information in the sensing measurement report frame.

Alternatively, or additionally, in an example of the present disclosure, the first frame includes a sensing measurement setup request frame.

Alternatively, or additionally, in an example of the present disclosure, the second frame includes any one of a beacon frame, a probe request frame, or a sensing query frame.

Alternatively, or additionally, in an example of the present disclosure, the third frame includes any one of a beacon frame or a probe response frame.

As illustrated in FIG. 7, an example of the present disclosure provides a communication apparatus 70, including a second communicating unit 71.

The second communicating unit 71 is configured to receive a first frame, where the first frame indicates whether a sensing measurement report frame carries time information or not, and the time information indicates a reception time or a transmission time of an NDP frame.

Alternatively, or additionally, in an example of the present disclosure, the first frame includes a first identifier bit. When the value of the first identifier bit includes a first value, the first frame indicates that the sensing measurement report frame carries the time information. When the value of the first identifier bit includes a second value, the first frame indicates that the sensing measurement report frame does not carry the time information.

Alternatively, or additionally, in an example of the present disclosure, the first frame includes sensing measurement parameter element fields, and a sensing measurement parameter field in the sensing measurement parameter element fields includes the first identifier bit.

Alternatively, or additionally, in an example of the present disclosure, the second communicating unit 71 is further configured to receive a second frame. The second frame indicates that the first device supports carrying the time information in the sensing measurement report frame.

Alternatively, or additionally, in an example of the present disclosure, the apparatus further includes a second determining unit. The second determining unit is further configured to determine a third frame. The third frame indicates that the communication apparatus supports carrying the time information in the sensing measurement report frame.

The second communicating unit 71 is further configured to transmit the third frame.

Alternatively, or additionally, in an example of the present disclosure, the first frame includes a sensing measurement setup request frame.

Alternatively, or additionally, in an example of the present disclosure, the second frame includes any one of a beacon frame, a probe request frame, or a sensing query frame.

Alternatively, or additionally, in an example of the present disclosure, the third frame includes any one of a beacon frame or a probe response frame.

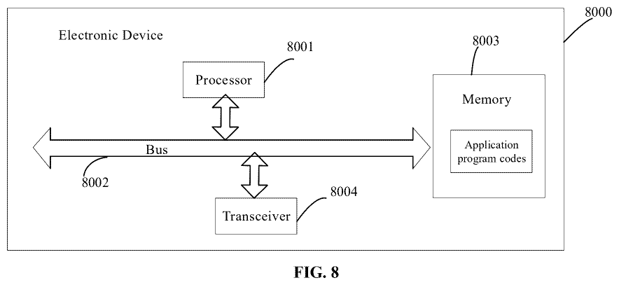

An example of the present disclosure further provides an electronic device, as illustrated in FIG. 8. The electronic device 8000 illustrated in FIG. 8 includes a processor 8001 and a memory 8003. The processor 8001 and the memory 8003 are connected, for example, via a bus 8002. Alternatively, or additionally, the electronic device 8000 may further include a transceiver 8004. It is to be noted that in actual applications, the number of transceivers 8004 is not limited to one, and the structure of the electronic device 8000 does not constitute a limitation on the examples of the present disclosure.

The memory 8003 is configured to store application program codes for executing the examples of the present disclosure, and the execution is controlled by the processor 8001. When the electronic device 8000 acts as a first device, the processor 8001 is configured to execute the application program codes stored in the memory 8003 to implement the communication methods applicable to the first device provided in the examples of the present disclosure. When the electronic device 8000 acts as a second device, the processor 8001 is configured to execute the application program codes stored in the memory 8003 to implement the communication methods applicable to the second device provided in the examples of the present disclosure.

The bus 8002 may include a channel for transmitting information between the above components. The bus 8002 may be a peripheral component interconnect (PCI) bus or an extended industry standard architecture (EISA) bus, etc. The bus 8002 may be divided into an address bus, a data bus, a control bus, and so on. For ease of representation, only a thick line is illustrated in FIG. 8, but it does not mean that there is only one bus or one type of bus.

The memory 8003 may be a read-only memory (ROM) or other types of static storage devices that can store static information and instructions, a random access memory (RAM) or other types of dynamic storage devices that can store information and instructions, or an electrically erasable programmable read-only memory (EEPROM), a compact disc read-only memory (CD-ROM) or other optical disk storage, an optical disc storage (including a compressed optical disc, a laser disc, an optical disc, a digital versatile disc, a Blu-ray disc, etc.), a magnetic disk storage medium or other magnetic storage devices, or any other medium that can be configured to carry or store the desired program codes in the form of instructions or data structures and can be accessed by a computer, but is not limited to these.

An example of the present disclosure provides a non-transitory computer-readable storage medium, on which a computer program is stored. The computer program, when running on a computer, enables the computer to perform the corresponding contents of the foregoing method examples.

Although the steps in the flowcharts of the accompanying drawings are displayed sequentially as indicated by the arrows, it is to be understood that these steps are not necessarily performed sequentially in the order indicated by the arrows. Unless otherwise specified herein, there is no strict order limitation for performing these steps, and these steps may be performed in other orders. In addition, at least part of the steps in the flowcharts of the accompanying drawings may include multiple sub-steps or multiple phases. These sub-steps or phases are not necessarily performed at the same time, but may be performed at different moments. The order of these sub-steps or phases is not necessarily sequential, but may rotate or alternate with at least part of another step, sub-steps, or phases thereof.

It is to be noted that the non-transitory computer-readable storage medium in the present disclosure may be a computer-readable signal medium, a computer-readable storage medium, or any combination of the two. The non-transitory computer readable storage medium may be, for example but not limited to, an electronic, magnetic, optical, electromagnetic, infrared, or semiconductor system, apparatus, or component, or any combination thereof. More specific examples of the non-transitory computer-readable storage medium may include, but are not limited to, an electrical connection having one or more conductors, a portable computer disk, a hard disk, an RAM, an ROM, an EPROM or a flash memory, an optical fiber, a portable compact disk-read-only memory (CD-ROM), an optical storage device, a magnetic storage device, or any suitable combination thereof. In the present disclosure, the non-transitory computer-readable storage medium may be any tangible medium that contains or stores a program that may be used by or in connection with an instruction execution system, apparatus, or device. In the present disclosure, a computer-readable signal medium may include data signals propagated in a baseband or as a part of a carrier wave, in which computer-readable program codes are carried. The propagated data signals may take a variety of forms, including but not limited to electromagnetic signals, optical signals, or any suitable combination thereof. The computer-readable signal medium may also be any computer-readable storage medium other than the computer-readable storage medium. The computer-readable signal medium may send, propagate, or transport the program that is used by or in combination with the instruction execution system, apparatus, or device. The program codes contained on the non-transitory computer-readable storage medium may be transmitted via any appropriate medium, including but not limited to: a wire, an optical cable, radio frequency (RF), etc., or any suitable combination thereof.

The non-transitory computer-readable storage medium may be included in the first device or the second device, or may exist independently without being installed in the first device or the second device.

The non-transitory computer-readable storage medium carries one or more programs. When the one or more programs are executed by the first device or the second device, the first device or the second device performs the corresponding communication methods.

According to one aspect of the present disclosure, a computer program product or a computer program is provided. The computer program product or the computer program includes computer instructions stored in a non-transitory computer-readable storage medium. One or more processors of the computer device read the computer instructions from the computer-readable storage medium and execute the computer instructions, so that the computer device performs the communication methods provided in the various candidate implementations.

Computer program codes for performing operations of the present disclosure may be written in one or more programming languages, or a combination thereof, including object-oriented programming languages such as Java, Smalltalk, C++, and conventional procedural programming languages such as “C” or similar programming languages. The program codes may be executed entirely on a user computer, partly on the user computer, as a stand-alone software package, partly on the user computer and partly on a remote computer, or entirely on the remote computer or server. In a case involving a remote computer, the remote computer may be connected to the user computer through any type of network, including a local area network (LAN) or a wide area network (WAN), or may be connected to an external computer, for example, through the Internet by an Internet service provider.

The flowcharts and block diagrams in the accompanying drawings illustrate possible implementation architectures, functions, and operations of the systems, the methods, and the computer program products according to various examples of the present disclosure. In this regard, each block in the flowchart or block diagram may represent a module, a program segment, or a portion of code, which contains one or more executable instructions for implementing the specified logical functions. It is also to be noted that, in some alternative implementations, the functions pointed by the blocks may occur out of the order pointed by the accompanying drawings. For example, two blocks shown in succession may actually be executed substantially in parallel, or may sometimes be executed in a reverse order, depending on the involved functions. It is also to be noted that each block in the block diagram and/or flowchart, and combinations of blocks in the block diagram and/or flowchart, may be implemented by a dedicated hardware-based system that performs a specified function or operation, or may be implemented by a combination of dedicated hardware and computer instructions.

The modules involved in the described examples of the present disclosure may be implemented by software or by hardware. The name of a module does not, in some cases, constitute a limitation on the module itself. For example, module A may also be described as “module A for performing operation B”.

The above description is only an illustration of the preferred examples of the present disclosure and the technical principles used in the present disclosure. Those skilled in the art should understand that the scope of disclosure involved in the present disclosure is not limited to the technical solutions formed by specific combinations of the above technical features, but should also cover other technical solutions formed by any combination of the above technical features or their equivalent features without departing from the disclosure concepts, for example, the technical solutions formed by replacing the above features with, but not limited to, the technical features having similar functions disclosed in the present disclosure.

1. A communication method, performed by a first device, the method comprising:
determining a first frame, wherein the first frame indicates whether a sensing measurement report frame carries time information or not, and the time information indicates a reception time or a transmission time of a null data packet (NDP) frame; and
transmitting the first frame.

2. The method according to claim 1, wherein the first frame comprises a first identifier bit;
wherein a value of the first identifier bit comprises a first value, and the first frame indicates that the sensing measurement report frame carries the time information, and
wherein the value of the first identifier bit comprises a second value, and the first frame indicates that the sensing measurement report frame does not carry the time information.

3. The method according to claim 2, wherein the first frame comprises sensing measurement parameter element fields, and a sensing measurement parameter field in the sensing measurement parameter element fields comprises the first identifier bit.

4. The method according to claim 1, wherein the first device is a sensing initiator, and the sensing initiator is a sensing transmitter.

5. The method according to claim 1, further comprising:
determining a second frame, wherein the second frame indicates that the first device supports carrying the time information in the sensing measurement report frame; and
transmitting the second frame.

6. The method according to claim 1, further comprising:
receiving a third frame, wherein the third frame indicates that a second device supports carrying the time information in the sensing measurement report frame.

7. The method according to claim 1, wherein the first frame comprises a sensing measurement setup request frame.

8. The method according to claim 5, wherein the second frame comprises any one of a beacon frame, a probe request frame or a sensing query frame.

9. The method according to claim 6, wherein the third frame comprises any one of a beacon frame or a probe response frame.

10. A communication method, performed by a second device, the method comprising:
receiving a first frame, wherein the first frame indicates whether a sensing measurement report frame carries time information or not, and the time information indicates a reception time or a transmission time of a null data packet (NDP) frame.

11. The method according to claim 10, wherein the first frame comprises a first identifier bit;
wherein a value of the first identifier bit comprises a first value, and the first frame indicates that the sensing measurement report frame carries the time information, and
wherein the value of the first identifier bit comprises a second value, and the first frame indicates that the sensing measurement report frame does not carry the time information.

12. The method according to claim 11, wherein the first frame comprises sensing measurement parameter element fields, and a sensing measurement parameter field in the sensing measurement parameter element fields comprises the first identifier bit.

13. The method according to claim 10, further comprising:
receiving a second frame, wherein the second frame indicates that a first device supports carrying the time information in the sensing measurement report frame.

14. The method according to claim 10, further comprising:
determining a third frame, wherein the third frame indicates that the second device supports carrying the time information in the sensing measurement report frame; and
transmitting the third frame.

15. The method according to claim 10, wherein the first frame comprises a sensing measurement setup request frame.

16. The method according to claim 13, wherein the second frame comprises any one of a beacon frame, a probe request frame or a sensing query frame.

17. The method according to claim 14, wherein the third frame comprises any one of a beacon frame or a probe response frame.

18. (canceled)

19. (canceled)

20. An electronic device, comprising:
one or more memories,
one or more processors, and
a computer program stored in the one or more memories and executable on the one or more processors,
wherein the one or more processors are configured to:
determine a first frame, wherein the first frame indicates whether a sensing measurement report frame carries time information or not, and the time information indicates a reception time or a transmission time of a null data packet (NDP) frame; and
transmit the first frame.

21. (canceled)

22. An electronic device, comprising:
one or more memories,
one or more processors, and
a computer program stored in the one or more memories and executable on the one or more processors,
wherein the one or more processors execute the program to implement the method according to claim 10.

23. The method according to claim 10, wherein the second device is a sensing responder.
